(19) United States
(12) Patent Application Publication
(10) Pub. No.: US 2010/0092619 A1
(43) Pub. Date: Apr. 15, 2010

(54) PORTION CONTROL CHEESE DISC FOR TOTAL PRODUCT UTILIZATION

(76) Inventor: John Bloom, Tarpon Springs, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 12/251,500

(22) Filed: Oct. 15, 2008

(51) Int. Cl. A23C 19/00; A23L 1/48

(52) U.S. Cl. 426/89; 426/582

(57) ABSTRACT

A pizza pie and its associated method of making the pizza pie wherein the pizza pie includes a cheese topping in the form of a cheese disc which has a generally uniform predetermined thickness and size, is placed on the pizza pie. The cheese disc is dimensioned so as to as to be located within an inside boundary of a formed perimeter crust of the pizza pie.

### FIELD OF THE INVENTION

The invention relates to making pizza using pre-portioned cheese discs to eliminate waste from shredded cheese falling outside the pizza pie and costs associated with such waste.

### BACKGROUND OF THE INVENTION

Pizza is generally prepared and sold in round pies with standard diameters of 12 inch, 14 inch, and 16 inch pies. Pizza is also prepared in equivalent sizes but in a square or rectangular form as opposed to round pies. In any case, these sizes can vary, depending on the maker or preparer.

What is well-known practice is that after the sauce and/or toppings are applied, cheese is applied to the top of the pie. This is done by spreading shredded cheese as uniformly as possible on the top of the pies. This shredded cheese is typically mozzarella cheese or sometimes a combination of mozzarella cheese and cheddar cheese. In most cases, pre-shredded cheese is sprinkled over the pie using a hand full of the cheese. The amount of cheese used varies on each pie based on the size of the pie maker's hands, the pie maker's opinion of full coverage, and the thickness of the sprinkled cheese that lands on the pie. In some cases, significantly more cheese is distributed over some portions of the pie and less over other portions, that is, uniform distribution is rarely, if ever, accomplished. Some customers may complain that they received less cheese than they have in the past, others may be very happy for receiving more cheese than expected. Uniformity results in consistency, a trait that all restaurants want to achieve.

Of primary concern with the above manual sprinkling of shredded cheese is the over use of cheese, thereby adding costs to the maker. Another concern is the over sprinkling where shredded cheese misses the pie surface and falls on the preparation table around the outside of the pie and/or on the floor. This waste of cheese that must be disposed of again adds to the maker's cost.

For a better idea of the scope of the concern regarding waste alone and not portion control from putting too much cheese on a pie, assume that the average waste for a 14 inch pizza pie is ¼ ounce of shredded cheese. If the daily production was 350 pies, the average daily waste would be about 5 pounds of shredded cheese and the average monthly waste would be about 150 pounds of the shredded cheese. One can easily surmise that the associated cost to the wasted cheese alone is extremely high and the profit of the pizza restaurant establishment is significantly reduced.

What is needed is a new method for making pizzas where cheese waste is eliminated and cheese portion control and uniformity over the pizza pie is achieved.

### SUMMARY OF THE INVENTION

The present invention facilitates cost control by the use of pre-portioned cheese discs in the preparation of pizza pies requiring cheese toppings, thereby eliminating cheese waste or over applications of shredded cheese on pizza pies.

The present invention provides a method of controlling the exact amount of cheese used in the preparation of pizza pies. Mozzarella cheese is one of the main components of a pizza pie as well as often the most expensive ingredient in a pizza pie.

The invention can best be understood by way of example. Assume the pizza pies are round pies and are 12 inch, 14 inch and 16 inch diameter pies. Pre-sized and weighed mozzarella cheese discs for these pizza pie sizes may respectively be 11 inch diameter (6 ounces), 13 inch diameter (8 ounces), and 15 inch diameter (10 ounces). Again, the above is merely an example as pizza pies can be square or rectangular shaped as well, therefore the pre-formed discs can be round or four sided in shape. For example, a Sicilian style pizza may be 7 inch square or 8 inch by 10 inch rectangular shaped. Many deep dish pizzas have various shaped (round, square or rectangular).

More generally, the present invention is a method of maintaining cheese portion control and eliminating cheese waste on a pizza pie. The method comprises providing cheese in the form of a cheese disc, which has a generally uniform predetermined thickness and size so as to be placed on an associated pizza pie, and making the associated pizza pie such that when the associated pizza pie requires a placement of a cheese topping, the cheese disc is placed on the associated pizza pie.

The generally uniform thickness provides for uniformity of the cheese over the pizza pie surface when the pizza pie is cooked and the cheese melts over the sauce,and/or toppings. The uniform thickness will also be designed so as to produce the desired weight of the cheese in the pre-portioned weighed cheese discs.

As alluded to above, pizza pies are typically formed as a round, square or rectangular shaped pizza pies. The pre-portioned packaged cheese discs are preferably dimensioned for anticipated standard size pizzas so as to as to be located within an inside boundary of a formed perimeter crust of the pizza pie when the cheese disc is placed on the pizza pie. In a four sided pizza pie, two discs may be used side-by-side, both within the overall inside boundary of the formed perimeter crust of the pizza pie, or a single disc may be used within the overall inside boundary of the formed perimeter crust of the pizza pie.

Although not limited to such cheeses, the cheese discs contemplated as typical examples of cheese that can be used with the present invention are cheeses selected from the group consisting of a mozzarella cheese or a combination of a mozzarella cheese and cheddar cheese.

A supplier or manufacturer of the cheese for pizza establishments or homes can provide such cheese discs as contemplated by the present invention as part as a pre-supplied package of a plurality of cheese discs separated by a paper divider, similar to paper divider material used to divide pre-packaged deli cheese. Although such divider paper is not really required, given the stickiness of mozzarella cheese, it is preferable to make the individual discs easier to work with by providing a paper type of separator or divider between the discs.

Although the basic cheese disc may have a smooth upper surface as found in most discs of deli cheese, in one embodiment, the cheese disc may have a textured upper surface that is designed, for example, by pressing the surface, with the appearance of shredded segments of cheese. In addition, a plurality of spaced-apart holes or apertures within the disc may also be provided such as randomly shaped and sized holes or any other predetermined shaped and sized holes.

### BRIEF DESCRIPTION OF THE DRAWINGS

In the accompanying drawings:

FIG. 1A is a depiction of an example of a prior art round pizza pie being prepared where the shredded cheese is being sprinkled in an area outside the boundary of the pizza pie, such over spread of cheese creating cheese waste;

FIG. 1B is a depiction of one embodiment of the present invention where a cheese disc is being placed on a round pizza pie and no cheese waste is created;

FIG. 2A is a depiction of another embodiment of the present invention where a cheese disc is being placed on a four sided pizza pie and no cheese waste is created;

FIG. 2B is a depiction of an example of a prior art four sided pizza pie being prepared where the shredded cheese is being sprinkled in an area outside the boundary of the pizza pie, such over spread of cheese creating cheese waste;

FIG. 3A is a depiction similar to that of FIG. 1B, except the cheese disc has multiple apertures or holes within the disc of cheese;

FIG. 3B is a depiction similar to that of FIG. 1B, except the cheese disc has a surface texture on at least the upper surface of the cheese disc;

FIG. 4A is a depiction similar to that of FIG. 2A, except the cheese disc has a surface texture on at least the upper surface of the cheese disc;

FIG. 4B is a depiction similar to that of FIG. 4A, except the cheese disc has multiple apertures or holes within the disc of cheese;

FIG. 5A is a depiction similar to that of FIG. 1B, except the pizza pie is general four-sided, in this case generally square shaped and a single disc of cheese is being placed on the pizza pie; and

FIG. 5B is a depiction similar to that of FIG. 2A, except a single disc of cheese is being placed on the generally rectangular shaped pizza pie.

### DETAILED DESCRIPTION OF THE INVENTION

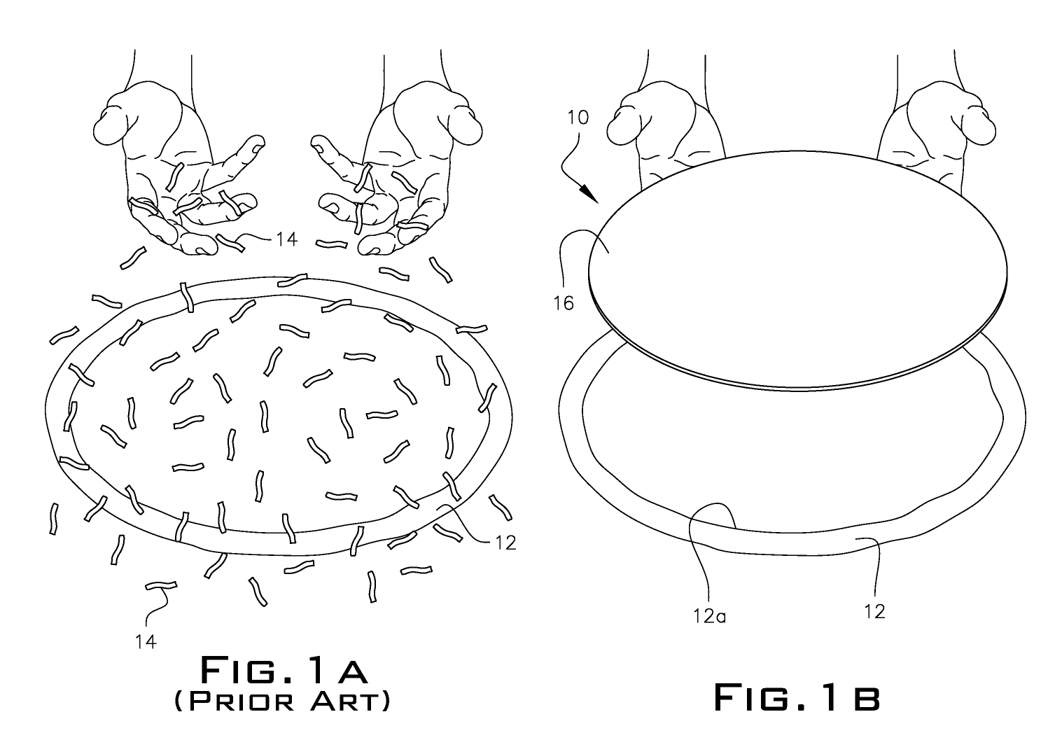

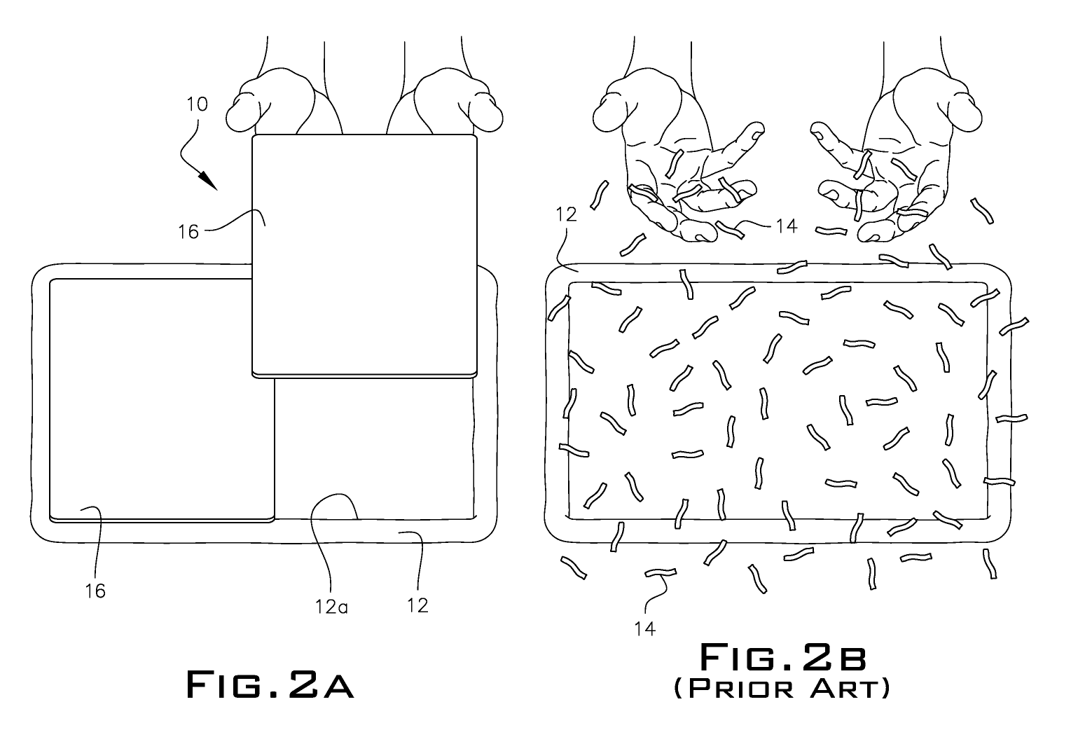

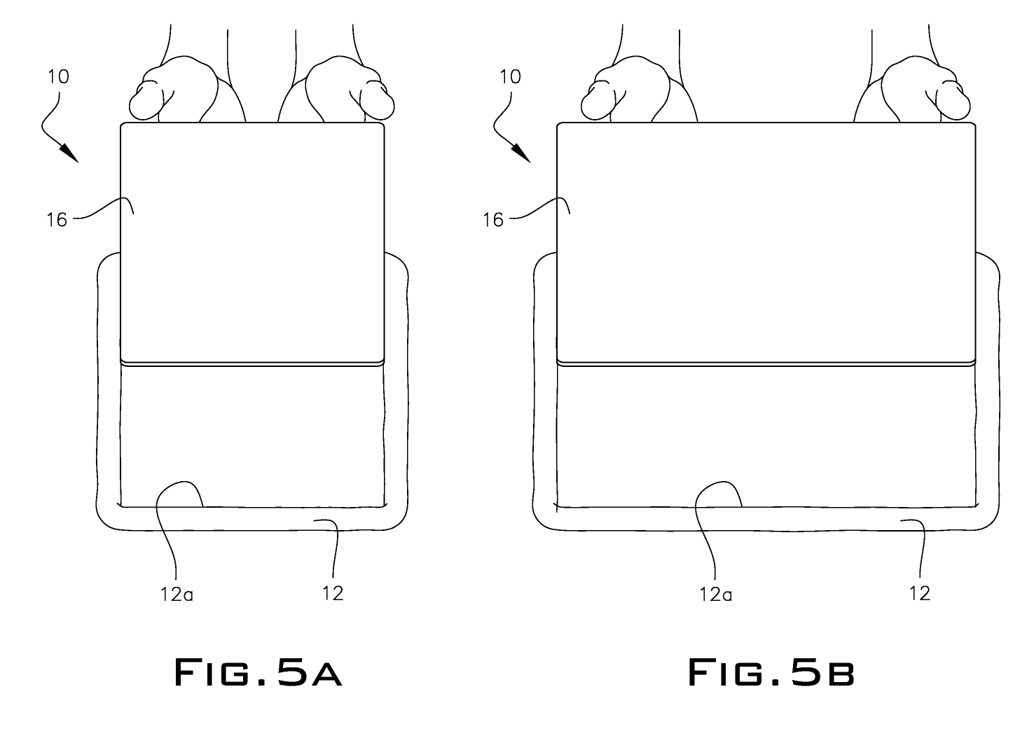

Referring now to the drawings, FIGS. 1B, 2A, 3A-3B, 4A-4B and 5A-5B disclose representative examples of the present invention, which is a novel pizza pie generally depicted as 10. FIGS. 1A and 2B are representative of the waste generated using the prior art method of sprinkling shredded cheese on a pizza pie. The invention is a pizza pie and its associated method of making the same 10 that comprises desired toppings on the pizza dough and further comprises cheese in the form of a cheese disc 16 having a generally uniform predetermined thickness and size, which is placed on the pizza pie 10 with its desired toppings.

For purposes of representation in the drawings, the pizza toppings, pizza dough and its form perimeter crust as a combination is generally denoted as 12. Shredded cheese shown in the prior art drawings FIGS. 1A and 2B is generally denoted as 14.

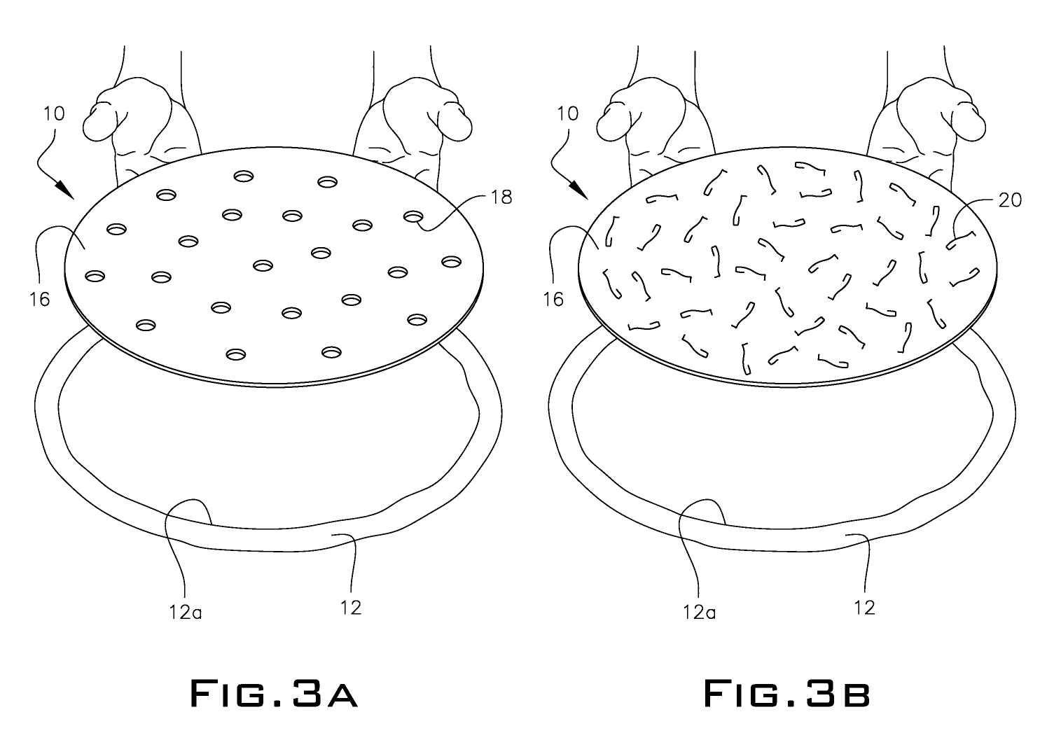

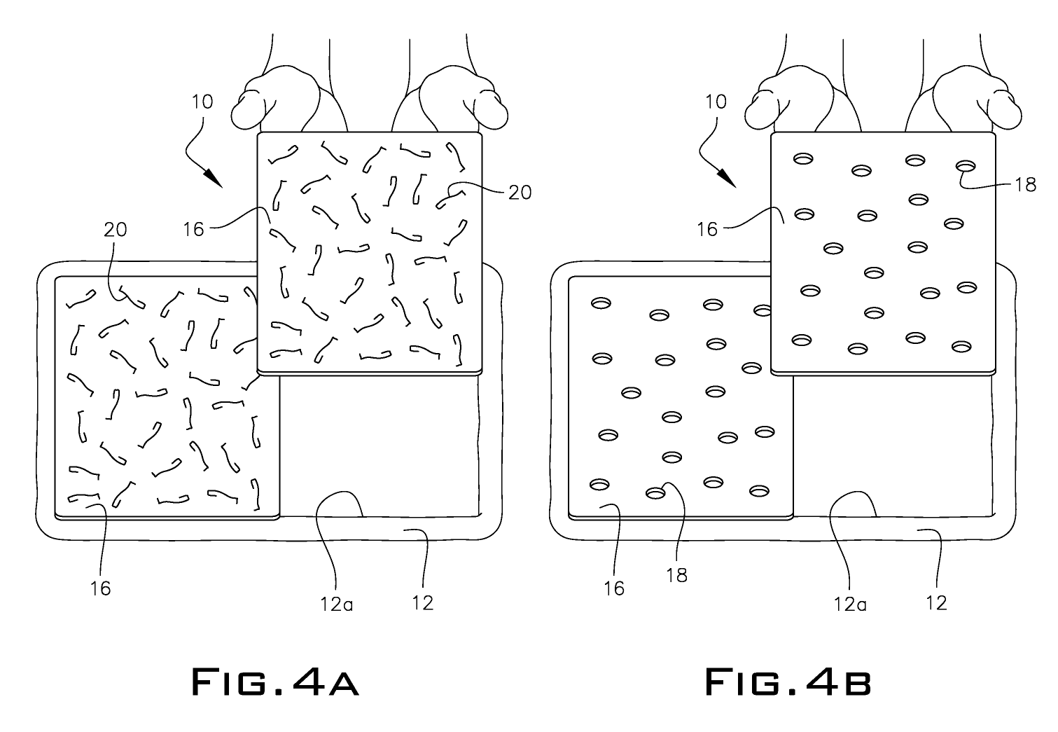

As depicted by way of examples only, the pizza pie 10 can be formed as a round shaped pie as in FIGS. 1B and 3A-3B or formed as a four sided shaped pizza pie as in FIGS. 2A, 4A-4B and 5A-5B. A four sided pie can be rectangular as shown or square as readily understood by those skilled in the art from the drawings and specifications herein. The cheese disc 16 is dimensioned so as to as to be located within an inside boundary of a formed perimeter crust 12a of the pizza pie when the cheese disc 16 is placed on the pizza pie's dough and toppings 12. When large size four-sided pizzas are made such as can be represented by FIGS. 2A, 4A-4B and 5A-5B, the pizza disc 16 may optionally be comprised of two pizza discs 16, each sized to be placed adjacent to each other and within the inside boundary of the formed perimeter crust 12a of the associated pizza pie. Optionally, it is understood from FIGS. 2A and 4A-4B that the use of two half moon shaped cheese discs is considered an equivalent option for round pizza pies.

As shown in FIGS. 3A and 4B, the pizza disc 16 may optionally include a plurality of spaced-apart holes or apertures 18 that can be randomly located within the pizza disc 16. This effect is similar to holes typically formed on Swiss cheese but is intended to provide an effect where the cheese melts around part of the toppings thus exposing some parts of the toppings.

Another optional embodiment is to incorporate a surface texture 20 as represented in FIGS. 3B and 4A, on at least an upper surface of the pizza disc 16, where the surface texture 20 represents a predetermined effect. For example, the cheese could be pressed so that the resultant texture 20 appears to have a shredded cheese appearance impressed within the cheese. Certainly, other impressions could be incorporated into the resultant texture.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A method of maintaining cheese portion control and eliminating cheese waste on a pizza pie thereby achieving total cheese product utilization, the method comprising:
providing cheese in the form of a cheese disc having a generally uniform predetermined thickness and size so as to be placed on an associated pizza pie; and
making said associated pizza pie and when said associated pizza pie requires a placement of a cheese topping, placing said cheese disc on said associated pizza pie.

2. The method according to claim 1, wherein said associated pizza pie is formed as a round or four sided pizza pie.

3. The method according to claim 1, wherein said cheese disc is dimensioned so as to as to be located within an inside boundary of a formed perimeter crust of said associated pizza pie when said cheese disc is placed on said associated pizza pie.

4. The method according to claim 1, wherein said cheese disc is selected from the group consisting of mozzarella cheese or a combination of mozzarella cheese and cheddar cheese.

5. The method according to claim 1, wherein said pizza disc has a surface texture on at least an upper surface of said pizza disc, said surface texture representing a predetermined effect.

6. The method according to claim 1, wherein said pizza disc includes a plurality of spaced-apart holes within said pizza disc.

7. The method according to claim 3, wherein said pizza disc is comprised of two pizza discs sized to be placed adjacent to each other and within said inside boundary of said formed perimeter crust of said associated pizza pie.

8. A pizza pie wherein when said pizza pie requires a placement of a cheese topping, said pizza pie further comprises:
cheese in the form of a cheese disc having a generally uniform predetermined thickness and size, said cheese disc being placed on said pizza pie.

9. The pizza pie according to claim 8, wherein said pizza pie is formed as a round or a four sided shaped pizza pie.

10. The pizza pie according to claim 8, wherein said cheese disc is dimensioned so as to as to be located within an inside boundary of a formed perimeter crust of said pizza pie when said cheese disc is placed on said pizza pie.

11. The pizza pie according to claim 8, wherein said cheese disc is selected from the group consisting of mozzarella cheese or a combination of mozzarella cheese and cheddar cheese.

12. The pizza pie according to claim 10, wherein said pizza disc is comprised of two pizza discs sized to be placed adjacent to each other and within said inside boundary of said formed perimeter crust of said associated pizza pie.

13. The pizza pie according to claim 8, wherein said pizza disc has a surface texture on at least an upper surface of said pizza disc, said surface texture representing a predetermined effect.

14. The pizza pie according to claim 8, wherein said pizza disc includes a plurality of spaced-apart holes within said pizza disc.
